(19) United States
(12) Patent Application Publication
(10) Pub. No.: US 2017/0183056 A1
(43) Pub. Date: Jun. 29, 2017

(54) BICYCLE DRIVE UNIT AND CONTROLLER

(71) Applicant: Shimano Inc., Osaka (JP)

(72) Inventor: Takashi YAMAMOTO, Osaka (JP)

(21) Appl. No.: 15/383,103

(22) Filed: Dec. 19, 2016

(30) Foreign Application Priority Data
Dec. 28, 2015 (JP) 2015-255098

(51) Int. Cl. B62M 6/50; F16H 63/50; B62M 11/14; B62M 6/90; B62M 6/55

(52) U.S. Cl. CPC B62M 6/50; B62M 6/90; B62M 6/55; B62M 11/145; F16H 63/50; B60Y 2200/13; B60Y 2200/91

(57) ABSTRACT

A bicycle drive unit is provided to assist a user when walking a bicycle on which the drive unit is mounted. A controller is provided to control the drive unit. The bicycle drive unit including a planetary gear mechanism, a first motor capable and a second motor. The planetary gear mechanism includes an input element receiving rotation of a crank of a bicycle, an output element sending rotation to an external element, and a transmission element controlling a rotation ratio between the input element and the output element. The first motor transmits a rotational force to one of the input element and the output element. The second motor transmit a rotational force to the transmission element. The control unit is configured to drive at least one of the first and second motors when an operation unit that excludes the crank is operated.

### CROSS-REFERENCE TO RELATED APPLICATIONS

This application claims priority to Japanese Patent Application No. 2015-255098, filed on Dec. 28, 2015. The entire disclosure of Japanese Patent Application No. 2015-255098 is hereby incorporated herein by reference.

### BACKGROUND ART

Field of the Invention

The present disclosure relates to a bicycle drive unit and a controller for the bicycle drive unit.

Japanese National Phase Laid-Open Patent Publication No. 2015-514635 describes a bicycle drive unit that includes a planetary gear mechanism and motors. The bicycle drive unit functions as an assist device that assists human power and also a gear change device.

### SUMMARY

A bicycle on which a bicycle drive unit is mounted is heavier than a bicycle that does not have a bicycle drive unit. It may be difficult to walk such a heavy bicycle. It is an object of the present disclosure to provide a bicycle drive unit that assists a user when the user walks a bicycle on which the bicycle drive unit is mounted. It is also an object of the present discloser to provide a controller for such a bicycle drive unit.

In a first aspect of the present disclosure, a controller is provided for a bicycle drive unit. The controller includes a control unit that controls the bicycle drive unit. The bicycle drive unit includes a planetary gear mechanism, a first motor, and a second motor. The planetary gear mechanism includes an input element, which receives rotation of a crank of a bicycle, an output element, which sends rotation to an external element, and a transmission element, which controls a rotation ratio between the input element and the output element. The first motor is capable of transmitting rotational force to one of the input element and the output element. The second motor is capable of transmitting rotational force to the transmission element. The control unit is control the bicycle drive unit by driving at least one of the first motor and the second motor when an operation unit that excludes the crank is operated.

In a second aspect of the present disclosure, in the controller according to the previous aspect, the first motor is configured to transmit rotational force to the input element. The input element is connected to the crank. The control unit is configured to drive the second motor when the operation unit is operated.

In a third aspect of the present disclosure, in a controller according to any of the previous aspects, the control unit configured to drive the second motor when the operation unit is operated under a predetermined first condition.

in a fourth aspect of the present disclosure, in a controller according to any of the previous aspects, the first condition includes at least one of a state in which the crank is substantially not rotating, a state in which the bicycle has a vehicle speed that is less than or equal to a first speed, and a state in which torque applied to the crank has a value that is less than a first predetermined value.

In a fifth aspect of the present disclosure, in a controller according to any of the previous aspects, the control unit is configured to switch between a ride mode in which at least the first motor is driven by human power and a walk mode in which at least the second motor is drivable when the operation unit is operated.

In a sixth aspect of the present disclosure, in a controller according to any of the previous aspects, in the walk mode, the control unit is configured to control the first motor to maintain a state in which the crank is substantially not rotating.

In a seventh aspect of the present disclosure, in a controller according to any of the previous aspects, the control unit is configured to stop the first motor to maintain the state in which the crank is substantially not rotating.

In an eighth aspect of the present disclosure, in a controller f according to any of the previous aspects, in the ride mode, the control unit is configured to control an output of the second motor to control a rotation speed of the output element relative to a rotation speed of the input element.

In a ninth aspect of the present disclosure, in a controller according to any of the previous aspects, the control unit switches between the ride mode and the walk mode based on an operation of the operation unit.

in a tenth aspect of the present disclosure, in a controller according to any of the previous aspects, in the walk mode, the control unit is configured to control an output of the second motor based on a vehicle speed of the bicycle.

In an eleventh aspect of the present disclosure, in a controller according to any of the previous aspects, in the walk mode, the control unit is configured to stop the second motor when the vehicle speed of the bicycle exceeds a predetermined second speed.

In a twelfth aspect of the present disclosure, in a controller according to any of the previous aspects, in the walk mode, the control unit configured to switch the walk mode to the ride mode when the crank receives torque having a second predetermined value or greater.

In a thirteenth aspect of the present disclosure, a bicycle drive unit includes the controller according to any of the previous aspects.

In a fourteenth aspect of the present disclosure, in the bicycle drive unit according to the previous aspect, the input element includes one of a ring gear and a planetary gear, the output element includes the other one of the ring gear and the planetary gear, and the transmission element includes a sun gear.

In a fifteenth aspect of the present disclosure, a bicycle drive unit according to the thirteenth or fourteenth aspect further includes a crank axle included in the crank.

The above bicycle drive unit and the controller for a bicycle drive unit are mounted on a bicycle and assist the user when walking the bicycle.

### BRIEF DESCRIPTION OF THE DRAWINGS

FIG. 1 is a side elevational view of a motor assisted bicycle (i.e., a pedelec) that is equipped with a bicycle drive unit in accordance with a first embodiment.

FIG. 2 is a cross-sectional view of the bicycle drive unit taken along section line 2-2 in FIG. 1.

FIG. 3 is a diagram of a planetary gear mechanism of the bicycle drive unit shown in FIG. 2.

FIG. 4 is a front face view of an operation unit and a display provided on the motor assisted bicycle shown in FIG. 1.

FIG. 5 is a block diagram of a controller for the bicycle drive unit shown in FIG. 1.

FIG. 6 is a flowchart of a walk mode executed by the controller shown in FIG. 5.

FIG. 7 is a cross-sectional view of a bicycle drive unit in accordance with a second embodiment.

### DESCRIPTION OF THE EMBODIMENTS

Selected embodiments of a bicycle drive unit will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

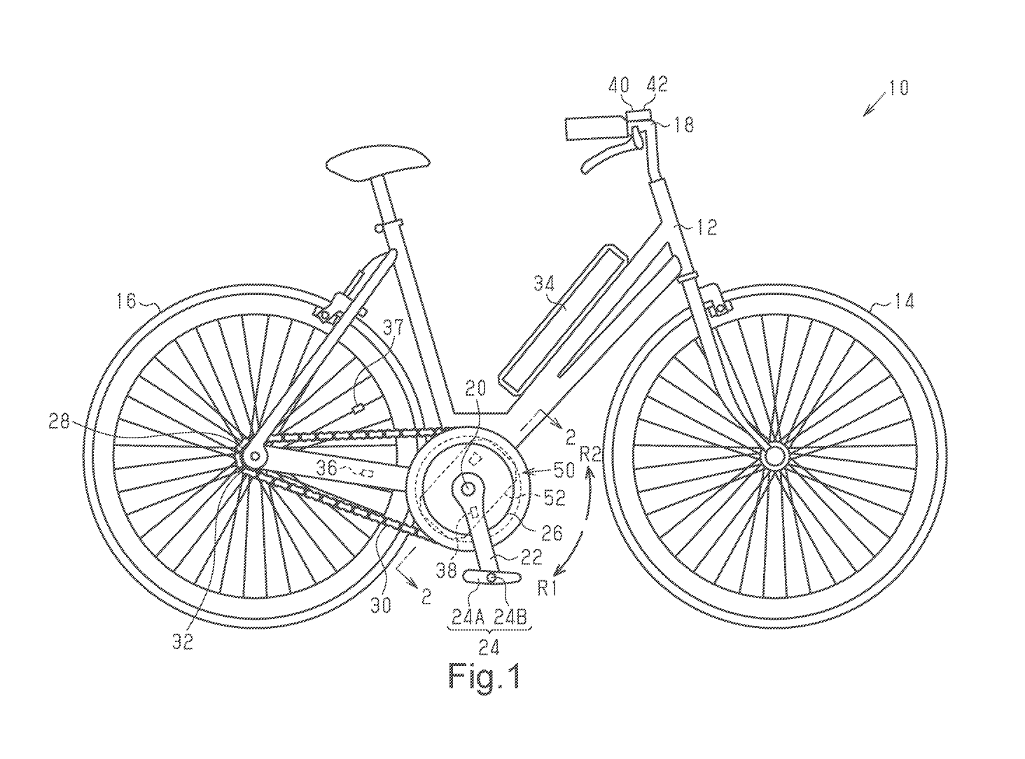

Referring initially to FIG. 1, a side elevational view of a motor assisted bicycle (i.e., a pedelec) 10 is illustrated that is equipped with a bicycle drive unit 50 in accordance with a first embodiment. The motor assisted bicycle 10 will hereafter be referred to as the “bicycle 10”. The bicycle drive unit 50 will hereafter be referred to as the “drive unit 50”). In one example, the bicycle 10 includes a frame 12, a front wheel 14, a rear wheel 16, a handlebar 18, a crank axle 20, two cranks 22, two pedals 24, a front sprocket 26, a rear sprocket 28, a chain 30 and a first one-way clutch 32.

The front wheel 14 and the rear wheel 16 are supported by the frame 12 and rotatable relative to the frame 12. The handlebar 18 is supported by the frame 12 and capable of changing the direction of the front wheel 14.

The drive unit 50 includes a housing 52 and the crank axle 20. The drive unit 50 functions to assist human power received by the cranks 22. The crank axle 20 is supported by the housing 52, and rotatable relative to the housing 52. The crank axle 20 is capable of rotating in a direction (hereafter, referred to as “forward rotation direction R1”) in which the bicycle 10 moves forward and a direction (hereafter, referred to as “reverse rotation direction R2”) opposite to the forward rotation direction R1.

The crank axle 20 includes two ends, which project from the housing 52. The cranks 22 are coupled to the ends of the crank axle 20 and capable of rotating integrally with the crank axle 20. Each of the pedals 24 includes a pedal body 24A and a pedal shaft 24B. The pedal shafts 24B are coupled to the cranks 22, and rotates integrally with the cranks 22. The pedal bodies 24A are supported by the corresponding pedal shafts 24B and rotatable relative to the pedal shafts 24B.

The front sprocket 26 is coupled to the drive unit 50. The rear sprocket 28 is coupled to the rear wheel 16 by the first one-way clutch 32. The chain 30 runs around the front sprocket 26 and the rear sprocket 28.

The bicycle 10 further includes a battery 34, a vehicle speed sensor 36 and a cadence sensor 38. The battery 34 is coupled to the frame 12 and supplies power to the drive unit 50. The vehicle speed sensor 36 is coupled to the frame 12, and detects the rotation speed of a magnet 37 located on the rear wheel 16 to measure the vehicle speed of the bicycle 10. Alternatively, the vehicle speed sensor 36 can detect the rotation speed of the front wheel 14. The cadence sensor 38 is coupled to the cranks 22 and measures (hereafter, referred to as “cadence”) the number of rotations of the cranks 22 per minute. In one example, the cadence sensor 38 includes a sensor that detects, for example, a magnet coupled to the cranks 22.

The bicycle 10 further includes a display 40 and an operation unit 42. In one example, the display 40 and the operation unit 42 are located proximate to a grip of the handlebar 18. The display 40 shows information related to the operation state of the bicycle 10 or the like. The information includes, for example, an operation mode of the drive unit 50. When the user operates the operation unit 42, a signal corresponding to the operation is transmitted to the drive unit 50.

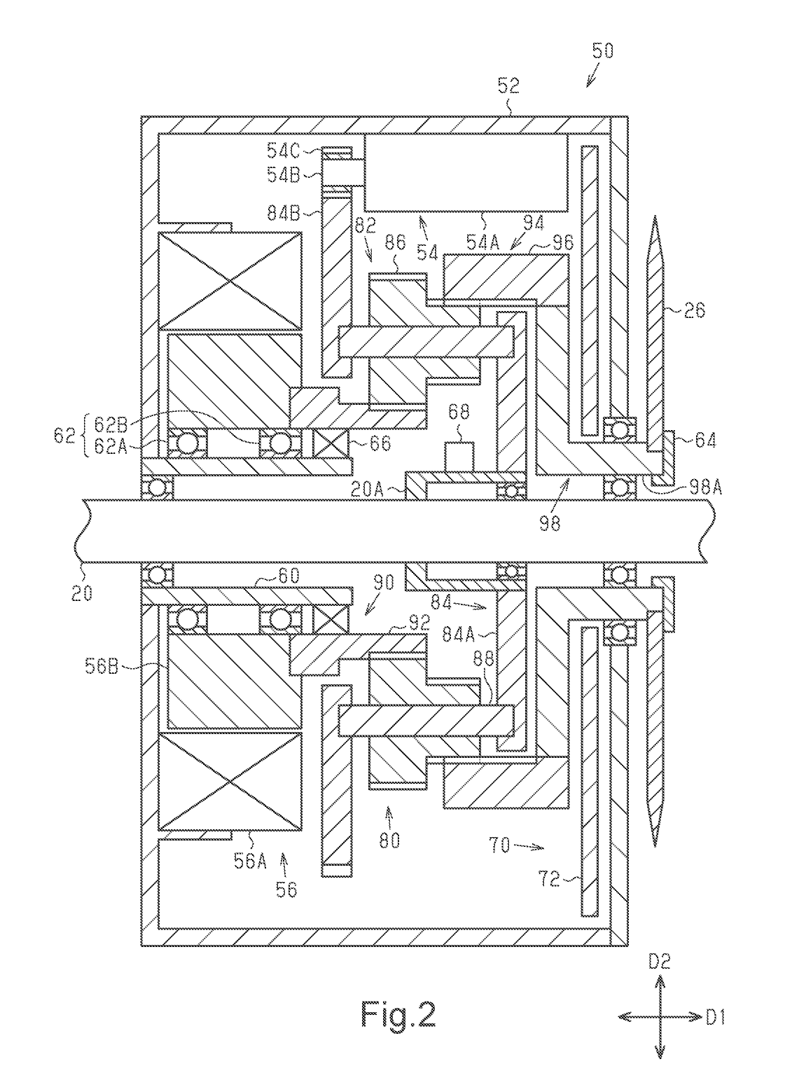

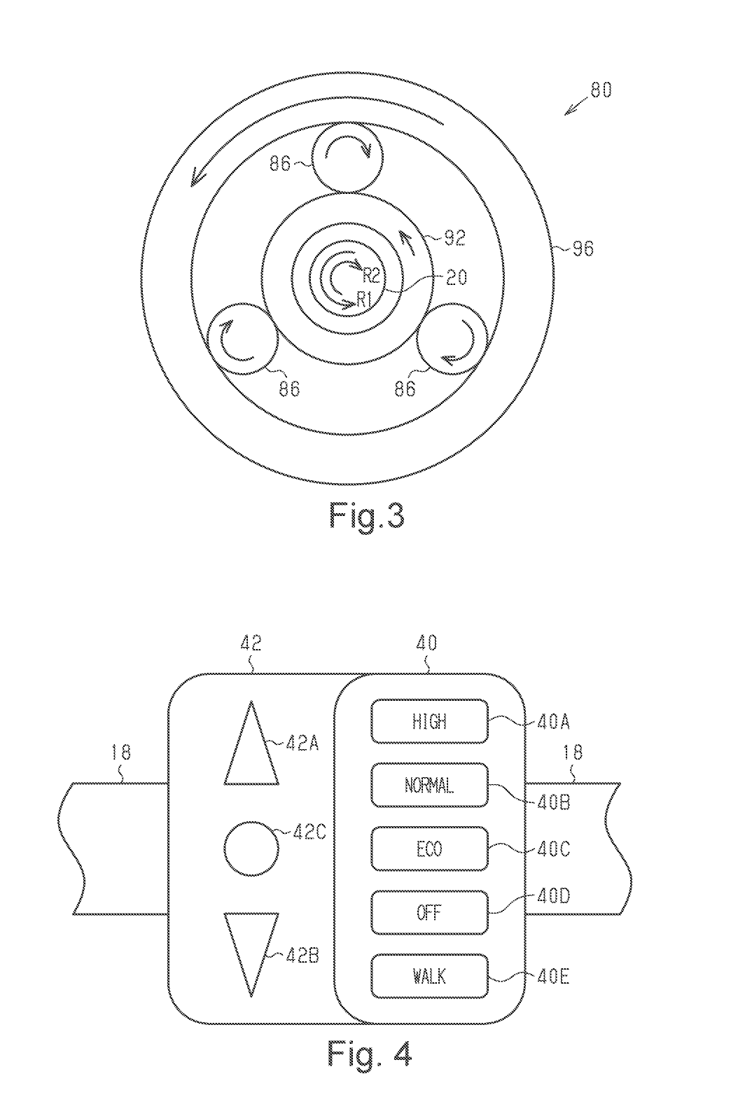

Referring to FIGS. 2 and 3, the drive unit 50 includes a first motor 54, a second motor 56, a controller 70 and a planetary gear mechanism 80. Preferably, the drive unit 50 further includes the housing 52, a support member 60, a pair of bearings 62, a bolt 64, a second one-way clutch 66, a torque sensor 68 and an output member 98. Preferably, the housing 52 accommodates the first motor 54, the second motor 56, the support member 60, the second one-way clutch 66, the torque sensor 68, the controller 70 and the planetary gear mechanism 80.

The first motor 54 includes a body 54A, a first motor shaft 54B, and a gear 54C. The body 54A includes a rotor and a stator, which are not shown in the drawings. The first motor shaft 54B extends parallel to a direction (hereafter, referred to as “first direction D1”) in which the rotational axis of the crank axle 20 extends. The gear 54C is coupled to the first motor shaft 54B, and transmits torque of the first motor 54 to the planetary gear mechanism 80, which includes an input element 82. The first motor 54 is capable of transmitting torque to the input element 82 of the planetary gear mechanism 80.

The second motor 56 is an inner rotor type that includes a stator 56A and a rotor 56B. The stator 56A is fixed to the housing 52. The stator 56A extends around the rotor 56B.

The support member 60 is tubular. The support member 60 is arranged coaxial with the crank axle 20. The support member 60 is located between the outer circumference of the crank axle 20 and the inner circumference of the rotor 56B. The support member 60 is fixed to the housing 52. The bearings 62 include a first bearing 62A and a second bearing 62B. The first bearing 62A supports the crank axle 20 so that the crank axle 20 is rotatable relative to the support member 60. The second bearing 62B supports the rotor 56B so that the rotor 56B is rotatable relative to the support member 60.

The torque sensor 08 measures torque received by the crank axle 20, that is, human power received by the pedals 24. The outer circumference of the crank axle 20 includes a tubular sleeve 20A, which is arranged coaxial with the crank axle 20. The sleeve 20A includes one end fixed to the crank axle 20. The sleeve 20A includes another end connected to a carrier 84. The torque sensor 68 is located on or around the sleeve 20A. The torque sensor 68 includes, for example, a strain gauge, a semiconductor strain sensor, or a magnetostriction sensor. When the torque sensor 68 includes a strain gauge or a semiconductor strain sensor, the strain gauge or the semiconductor strain sensor and a wireless transmitter are located on an outer circumferential surface of the sleeve 20A, and signals are transmitted through wireless communication by the controller 70. When the torque sensor 68 includes a magnetostriction sensor, a magnetostriction element is located on the outer circumferential surface of the sleeve 20A, and the magnetostriction sensor is located around the magnetostriction element. The magnetostriction sensor is, for example, fixed to the housing 52. The present embodiment includes the torque sensor 68. Instead, for example, as described in Japanese Laid-Open Patent Publication No. 2015-514635, the controller 70 can measure human power based on the current of at least one of the first motor 54 and the second motor 56. When the torque sensor 68 is not included, the sleeve 20A can be omitted, and the carrier 84 can be fixed to the crank axle 20.

The planetary gear mechanism 80 includes the input element 82, a transmission element 90, and an output element 94. The input element 82 receives rotation of the cranks 22 of the bicycle 10. The output element 94 sends the rotation of the cranks 22 to an external element. The transmission element 90 controls the ratio between the rotation speed of the input element 82 and the rotation speed of the output element 94.

The transmission element 90 includes a sun gear 92. The sun gear 92 extends around the crank axle 20, and is rotatable relative to the crank axle 20. The second motor 56 is capable of transmitting torque to the sun gear 92. In one example, the rotor 55B includes an end that is coupled to the sun gear 92 so that the rotor 56B is rotates integrally with the sun gear 92. The second motor 56 is capable of transmitting rotational force to the transmission element 90. The transmission element 90 is arranged coaxial with the crank axle 20.

The second one-way clutch 66 is located between the inner circumference of the sun gear 92 and the outer circumference of the support member 60. In one example, the second one-way clutch 66 is formed by a roller clutch or a pawl-type clutch. The second one-way clutch 66 functions to allow for rotation of the sun gear 92 in the reverse rotation direction R2 and restrict rotation of the sun gear 92 in the forward rotation direction R1 relative to the support member 60. Thus, rotation of the sun gear 92 is disabled in the forward rotation direction R1 relative to the support member 60.

The output element 94 includes a ring gear 96. The ring gear 96 extends around the sun gear 92 and is rotatable relative to the housing 52. The ring gear 96 can be offset from the sun gear 92 in a direction orthogonal to the rotational axis of the crank axle 20. The output member 98 is fixed to the inner circumference of the ring gear 96 and rotates integrally with the ring gear 96. The output member 98 can be formed integrally with the ring gear 96. The output member 98 is supported by the housing 52, and rotatable relative to the housing 52 with a bearing located in between. The crank axle 20 includes two axial ends arranged in a direction in which the rotational axis of the crank axle 20 extends. One axial end of the crank axle 20 is rotationally supported by the output member 98 with a bearing located in between. The other axial end of the crank axle 20 is rotationally supported by the housing 52 with a hearing located in between. The output member 98 includes an end 98A, which projects from the housing 52. The bolt 64 is fitted into the end 98A of the output member 98. The front sprocket 26 is located beside the housing 52 and fastened to the output member 98 by the bolt 64.

The input element 82 includes planetary gears 86. Preferably, the input element 82 further includes the carrier 84 and planetary pins 88. In one example, the input element 82 includes three planetary gears 86. The number of planetary gears 86 can be changed to one, two, or four or more.

The carrier 84 is coupled to the crank axle 20, and rotates integrally with the crank axle 20. The carrier 84 extends around the crank axle 20. The carrier 84 includes a first portion 84A and a second portion 84B. The first portion 84A is fixed to the sleeve 20A. The first portion 84A and the second portion 84B are located at opposite sides of the planetary gears 86 in a first direction D1. The rotational axis of the carrier 84 is aligned with the rotational axis of the crank axle 20. The second portion 84B includes an outer circumference that includes a gear. The gear of the second portion 84B engages the gear 54C.

Each of the planetary pins 88 is coupled to the first portion 84A and the second portion 84B and rotates integrally with the carrier 84. The planetary gears 86 are located between the sun gear 92 and the ring gear 96 in a direction (hereafter, referred to as “second direction D2”) orthogonal to the first direction D1. Each planetary gear 86 is supported by the planetary pin 88 and rotatable relative to the planetary pin 88. The planetary gear 86 and the planetary pin 88 are coaxial. When the planetary pin 88 is rotationally supported by the carrier 84, the sun gear 92 can be fixed to the planetary gear 86.

The drive unit 50 is operated in a number of modes. The operation modes include a ride mode and a walk mode. The ride mode is executed in a state (hereafter, referred to as “ride state”) in which the user is riding the bicycle 10, The walk mode is executed in a state (hereafter, referred to as “walk state”) in which the user is walking the bicycle 10.

The ride mode includes a HIGH mode, a NORMAL mode, an ECO mode, and an OFF mode. In the NORMAL mode, at least the first motor 54 is driven. In the OFF mode, at least the first motor 54 is not driven. In the HIGH mode, at least the first motor 54 is driven. The HIGH mode generates a larger assist force than the NORMAL mode in a predetermined range vehicle speed. In the ECO mode, at least the first motor 54 is driven. The ECO mode generates a smaller assist force than the NORMAL mode in a predetermined vehicle speed range.

FIG. 4 shows one example of the display 40, which includes an LED display unit. The LED display unit includes first to fifth display lamps 40A to 40E. The first display lamp 40A is illuminated when the operation mode of the drive unit 50 is the HIGH mode. The second display lamp 40B is illuminated when the operation mode of the drive unit 50 is the NORMAL mode. The third display lamp 40C is illuminated when the operation mode of the drive unit 50 is the ECO mode. The fourth display lamp 40D is illuminated when the operation mode of the drive unit 50 is the OFF mode. The fifth display lamp 40E is illuminated when the operation mode of the drive unit 50 is the walk mode. In another example, the display 40 includes a liquid crystal display unit. In this case, the liquid crystal display unit can show characters corresponding to each operation mode.

The operation unit 42 includes a first switch 42A, a second switch 42B, and a third switch 42C. In one example, each of the switches 42A to 42C is of a push-button type or a sliding type. The first switch 42A is operated to increase the assist force in the ride mode or switch the walk mode to the ride mode. The second switch 42B is operated to decrease the assist force in the ride mode, switch the ride mode to the walk mode, or drive the second motor 56 in the walk mode. The third switch 42C is operated when switching gear change modes. When each of the switches 42A to 42C is operated, an operation signal is transmitted to the drive unit 50. A memory 76 stores information of the assist ratio that is set for the ride mode. Each gear change mode can include an automatic gear change mode and a manual gear change mode. In the automatic gear change mode, the controller 70 can change the ratio of the rotation speed of the output member 98 relative to the crank axle 20 based on human power so that the human power is maintained in a predetermined range. The controller 70 drives the second motor 56 to change the ratio of the rotation speed of the output member 98 relative to the crank axle 20. In the manual gear change mode, the controller 70 can set the ratio of the rotation speed of the output member 98 relative to the crank axle 20 to a predetermined ratio, for example, based on an input operation performed on the operation unit 42. In the manual gear change mode, the controller 70 increases or decreases the gear ratio, for example, based on operation performed on a gear change switch arranged separately from the operation unit 42. The memory 76 stores information of the gear ratio that is set for the manual gear change mode.

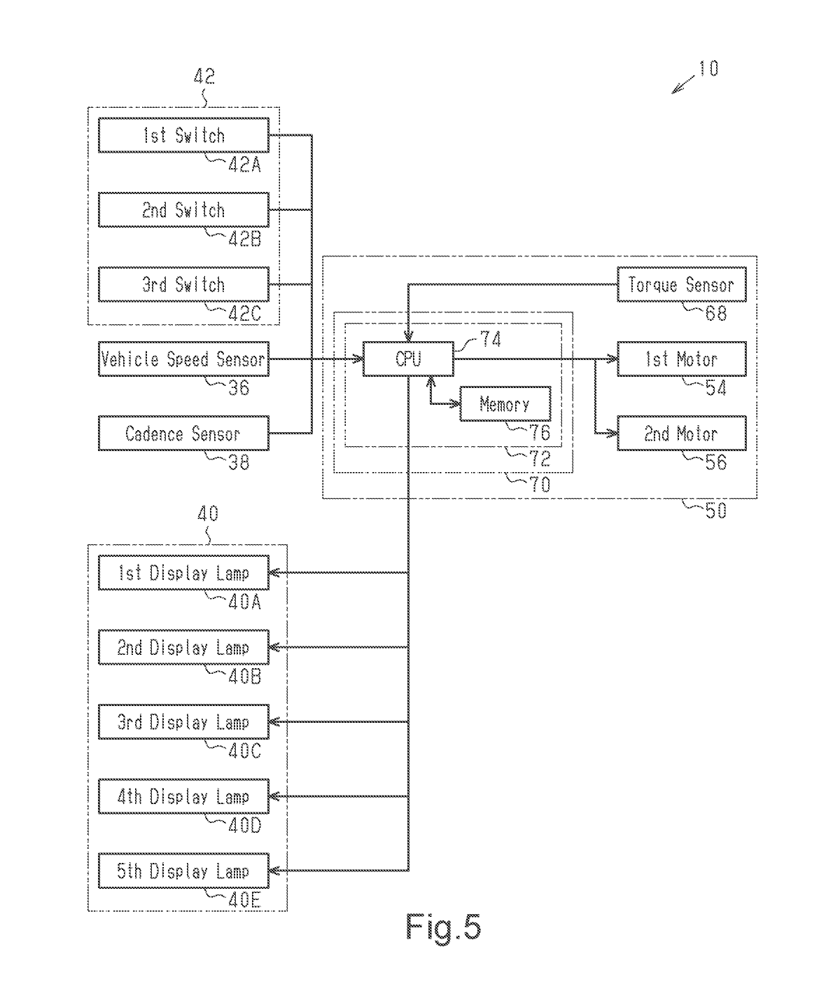

FIG. 5 is a block diagram of the controller 70 and components related to the controller 70. The controller 70 includes a control unit 72. The control unit 72 includes central processing unit 74 (CPU) and the memory 76, in one example, the memory 76 includes a nonvolatile memory and stores control programs, which are executed by the CPU, and different kinds of set information. The control unit 72 is electrically connected to the vehicle speed sensor 36, the cadence sensor 38, the display 40, the operation unit 42, the first motor 54, the second motor 56 and the torque sensor 68.

The control unit 72 is programmed to perform a plurality of functions. A first function is for calculating the cadence based on the measurement result of the cadence sensor 38. A second function is for calculating the vehicle speed of the bicycle 10 based on the measurement result of the vehicle speed sensor 36. A third function is for calculating the human power based on the measurement result of the torque sensor 68 or the current of at least one of the first motor 54 and the second motor 55. A fourth function is for showing the calculated vehicle speed and the cadence on the display 40. A fifth function is for controlling at least one of the first motor 54 and the second motor 56 when the operation unit 42, which excludes the cranks 22, is operated. A sixth function is for switching between the ride mode, in which at least the first motor 54 is driven by human power, and the walk mode, in which at least the second motor 56 is drivable when the operation unit 42 is operated. The control unit 72 only needs to include at least the fifth function.

The control unit 72 determines the output torque of the first motor 54 and the second motor 56 based on the human power and the set information of the assist ratio and the gear ratio, which are stored in the memory 76, and then controls the first motor 54 and the second motor 56. Preferably, the control unit 72 further determines the output torque of the first motor 54 and the second motor 56 based on the vehicle speed. The control unit 72 decreases the output torque of the first motor 54, for example, when the vehicle speed is greater than or equal to a predetermined second speed. The control unit 72 stops the first motor 54, for example, when the vehicle speed is greater than or equal to a predetermined first speed. The second speed is set to be lower than the first speed. The assist ratio is the ratio of assist force to human power. The control unit 72 controls output torque of the first motor 54 and the second motor 56 so that the output torque of the first motor 54 and the second motor 56 generates assist force that has a predetermined ratio to human power. The control unit 72 can use tables or arithmetic expressions when determining the output torque of the first motor 54 and the second motor 56.

The control unit 72 adjusts the level of the assist force by controlling the output of the second motor 56. Increases in the output of the second motor 56 increase the ratio of the torque applied to the input element 82 from the second motor 56 to the torque applied to the input element 82 from the crank axle 20. Thus, the assist force is increased. Decreases in the output of the second motor 50 decreases the ratio of the torque applied to the input element 82 from the second motor 56 to the torque applied to the input element 82 from the crank axle 20. Thus, the assist force is decreased.

The control unit 72 executes multiple controls in the walk mode. The multiple controls include a first control, a second control and a third control. In the first control, the control unit 72 controls the first motor 54 to maintain a state in which the cranks 22 are substantially not rotating. In one example, the control unit 72 maintains the substantially non-rotating state of the cranks 22 by keeping the first motor 54 in a stopped state.

In the second control, the control unit 72 drives the second motor 56 when the operation unit 42 is operated. In one example, the control unit 72 drives the second motor 56 when the operation unit 42 is operated under a predetermined first condition. The first condition includes, for example, at least one of a state in which the cranks 22 are substantially not rotating, a state in which the vehicle speed of the bicycle 10 is less than or equal to a first speed, and a state in which torque applied to the cranks 22 has a value less than a first predetermined value. The first speed is set in advance to allow for determination that the vehicle speed of the bicycle 10 is included in a range of the vehicle speed that would be obtained in the walk state. The first speed is, for example, 5 km/h. The first predetermined value is set in advance to determine that the cranks 22 receive human power.

In the third control, when driving the second motor 56 in response to an operation of the operation unit 42, the control unit 72 controls the output of the second motor 56 based on the vehicle speed of the bicycle 10. In one example, the control unit 72 controls the second motor 56 so that the vehicle speed of the bicycle 10 is set to a second speed. When driving the second motor 56 in response to an operation of the operation unit 42, the control unit 72 increases the output of the second motor 56 if the vehicle speed of the bicycle 10 is lower than the second speed and decreases the output of the second motor 56 if the vehicle speed of the bicycle 10 is higher than the second speed. When the vehicle speed is greater than or equal to the first speed, the control unit 72 stops the driving of the second motor 56. The second speed is set to, for example, 3 to 5 km/h. The memory 76 stores information related to the first speed and the second speed. The second speed can be changeable by the user.

In another example, in the third control, the control unit 72 can control the drive unit 50 based on the torque of the second motor 56 instead of the vehicle speed. The control based on torque conforms to the control based on vehicle speed.

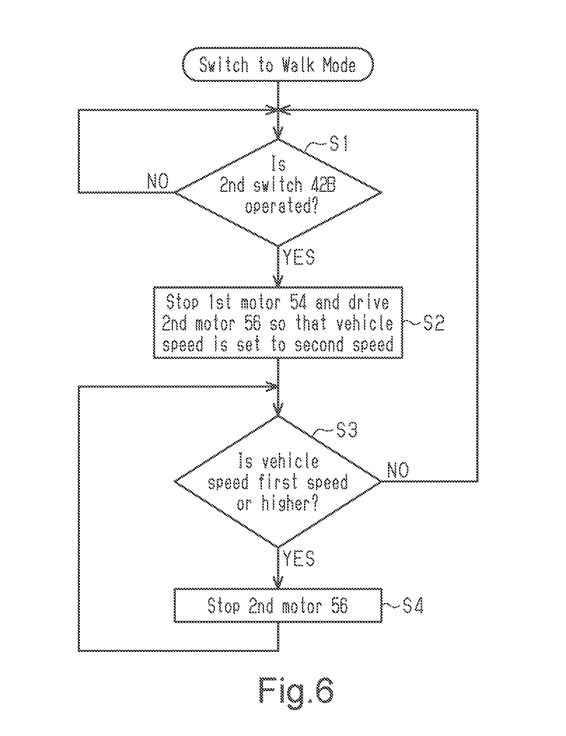

FIG. 6 is a flowchart showing the procedures of the walk mode performed by the controller 70.

When the operation unit 42 is operated to shift to the walk mode from the ride mode, in step S1, the control unit 72 starts the procedures of the walk mode. In step the control unit 72 determines whether or not the second switch 42B is operated. For example, when the second switch 42B is of a push-button type, the control unit 72 determines whether or not the second switch 42B is pushed. When it is determined that the second switch 42B is pushed, the control unit 72 proceeds to step S2. In step S2, the control unit 72 stops the first motor 54 and drives the second motor 56 based on a signal from the vehicle speed sensor 36 so that the vehicle speed is set to the second speed. Then, in step S3, the control unit 72 determines whether or not the vehicle speed is greater than or equal to the first speed based on a signal from the vehicle speed sensor 36. When it is determined that the vehicle speed is greater than or equal to the first speed, the control unit 72 proceeds to step S4. The vehicle speed can be greater than or equal to the first speed, for example, when the user is walking downhill or walking faster while pushing the bicycle 10. In step S4, the control unit 72 stops the driving of the second motor 56 and proceeds to step S3. In step S1, when it is determined that the second switch 42B is not operated, the control unit 72 performs step S1 after a predetermined time elapses. In step S3, when it is determined that the vehicle speed is lower than the first speed, the control unit 72 proceeds to step S1.

In step S3, the control unit 72 only determines whether or not the vehicle speed is greater than or equal to the first speed. Instead, in step S3, the control unit 72 can determine at least one of whether or not the vehicle speed is greater than or equal to the first speed, whether or not the cranks 22 are rotating, and whether or not human power is of a predetermined value or greater. The control unit 72 determines whether or not the cranks 22 are rotating based on a signal from the cadence sensor 38. Preferably, in step S3, the control unit 72 performs three determinations, that is, whether or not the vehicle speed is greater than or equal to the first speed, whether or not the cranks 22 are rotating, and whether or not human power is of the predetermined value or greater. In this case, when it is determined that the vehicle speed is greater than or equal to the first speed, that the cranks 22 are rotating, or that human power is of the predetermined value or greater, the control unit 72 proceeds to step S4. In step S2, the control unit 72 can drive the second motor 56 so that the torque of the second motor 56 has a predetermined value instead of the vehicle speed.

The first embodiment has the advantages described below.

(1) The drive unit 50 includes the planetary gear mechanism 80, the first motor 54, which is capable of transmitting rotational force to the input element 82, the second motor 56, which is capable of transmitting rotational force to the transmission element 90, and the control unit 72. The control unit 72 is capable of controlling at least one of the first motor 54 and the second motor 56 when the operation unit 42 is operated. The drive unit 50, which changes gears with the planetary gear mechanism 80 using the first motor 54 and the second motor 56, is mounted on the bicycle 10. This reduces the load on the user when walking the bicycle 10.

(2) In the walk mode, the control unit 72 controls the first motor 54 to maintain the substantially non-rotating state of the cranks 22. In this configuration, the cranks 22 do not rotate when the user walks the bicycle 10. This limits contact of the cranks 22 with the legs of the user.

(3) In the walk mode, the control unit 72 stops the second motor 56 when the vehicle speed of the bicycle 10 exceeds the predetermined second speed. This configuration limits excessive increases in the vehicle speed of the bicycle 10 when the user walks the bicycle 10.

### Second Embodiment

A second embodiment of a drive unit 100 differs from the first embodiment of the drive unit 50 in the points described below but otherwise has substantially the same structure as the first embodiment of the drive unit 50.

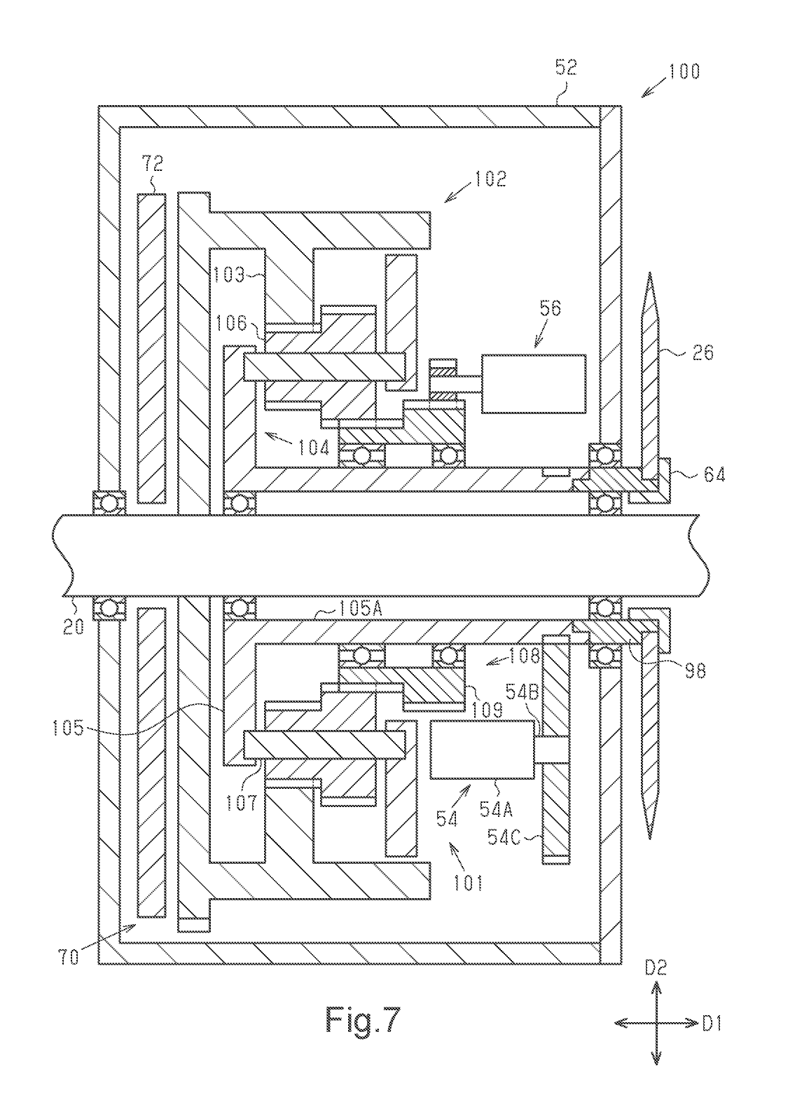

FIG. 7 is a cross-sectional view of the drive unit 100 of the second embodiment. The drive unit 100 includes a second planetary gear mechanism 101. The second planetary gear mechanism 101 includes a second input element 102, a second output element 104, and a second transmission element 106. The second input element 102 includes a second ring gear 103. The second output element 104 includes a second carrier 105, a second planetary gear 106, and a second planetary pin 107. The second transmission element 108 includes a second sun gear 109.

The crank axe 20 is coupled to the second input element 102. The rotation applied to the cranks 22 is transmitted to the second input element 102. This rotates the second ring gear 103. The second carrier 105 rotationally supports the second planetary gear 106. The second carrier 105 is coupled to the output member 98. The second carrier 105 includes a tubular portion 105A, which is arranged coaxial with the crank axle 20. The tubular portion 105A rotationally supports the second sun gear 109 with bearings located in between. The second motor 56 includes a rotation shaft, which is spaced apart from the crank axe 20. The first motor 54 is capable of transmitting torque to the second output element 104. The tubular portion 105A includes an end including a gear. The gear of the tubular portion 105A engages the gear 54C, which is coupled to the first motor shaft 54B. The second embodiment has advantages (1) to (3) of the first embodiment.

### Modified Examples

The above description is intended to be illustrative, and not restrictive. The bicycle drive unit according to the present disclosure can be modified as follows. Further, two or more of the modified examples can be combined.

The drive unit 50 of the first embodiment does not have to include the crank axle 20. In this case, the drive unit 50 is provided with a crank axle 20 that is a component of the bicycle 10. The drive unit 100 of the second embodiment can be modified in the same manner.

The drive unit 50 of the first embodiment can be located at any position. In one example, the drive unit 50 can be located proximate to the rear sprocket 28. The drive unit 100 of the second embodiment can be modified in the same manner.

In the drive unit 50 of the first embodiment, the first motor 54 can be configured to be connected to the output element 94 instead of the input element and produce rotation. In this case, the outer circumference of the output element 94 includes a gear that engages the gear 54C.

In the drive unit 100 of the second embodiment, the first motor 54 can be configured to be connected to the second input element 102 instead of the second output element 104 and produce rotation, in this case, the outer circumference of the second input element 102 includes a gear that engages the gear 54C.

In step S2, the control unit 72 can drive only the first motor 54 or both of the first motor 54 and the second motor 56 instead of driving only the second motor 56.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words haying similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the bicycle component. Accordingly, these directional terms, as utilized to describe the bicycle component should be interpreted relative to a bicycle in an upright riding position on a horizontal surface and that is equipped with the bicycle component. The terms “left” and “right” are used to indicate the “right” when referencing from the right side as viewed from the rear of the bicycle, and the “left” when referencing from the left side as viewed from the rear of the bicycle.

Also it will be understood that although the terms “first” and “second” may be used herein to describe various components these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and, “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A controller for a bicycle drive unit that includes: a planetary gear mechanism that includes: an input element, which receives rotation of a crank of a bicycle, an output element, which sends rotation to an external element, and a transmission element, which controls a rotation ratio between the input element and the output element; a first motor capable of transmitting rotational force to one of the input element and the output element; and a second motor capable of transmitting rotational force to the transmission element, the controller comprising:
a control unit configured to control the bicycle drive unit by driving at least one of the first motor and the second motor when an operation unit that excludes the crank is operated.

2. The controller according to claim 1, wherein
the first motor is configured to transmit rotational force to the input element,
the input element is connected to the crank, and
the control unit is configured to drive the second motor when the operation unit is operated.

3. The controller for a bicycle drive unit according to claim 2, wherein
the control unit is configured to drive the second motor when the operation unit is operated under a predetermined first condition.

4. The controller according to claim 3, wherein
the first condition includes at least one of a state in which the crank is substantially not rotating, a state in which the bicycle has a vehicle speed that is less than or equal to a first speed, and a state in which torque applied to the crank has a value that is less than a first predetermined value.

5. The controller according to claim 1, wherein
the control unit is configured to switch between a ride mode in which at least the first motor is driven by human power and a walk mode in which at least the second motor is drivable when the operation unit is operated.

6. The controller according to claim 5, wherein
in the walk mode, the control unit is configured to control the first motor to maintain a state in which the crank is substantially not rotating.

7. The controller according to claim 6, wherein
the control unit is configured to stop the first motor to maintain the state in which the crank is substantially not rotating.

8. The controller according to claim 5, wherein
in the ride mode, the control unit is configured to control an output of the second motor to control a rotation speed of the output element relative to a rotation speed of the input element.

9. The controller according to claim 5, wherein
the control unit is configured to switch between the ride mode and the walk mode based on an operation of the operation unit.

10. The controller according to claim 5, wherein
in the walk mode, the control unit is configured to control an output of the second motor based on a vehicle speed of the bicycle.

11. The controller according to claim 10, wherein
in the walk mode, the control unit is configured to stop the second motor when the vehicle speed of the bicycle exceeds a predetermined second speed.

12. The controller according to claim 5, wherein
in the walk mode, the control unit is configured to switch the walk mode to the ride mode when the crank receives torque having a second predetermined value or greater.

13. A bicycle drive unit comprising the controller according to claim 1.

14. The bicycle drive unit according to claim 13, wherein
the input element includes one of a ring gear and a planetary gear,
the output element includes the other one of the ring gear and the planetary gear, and
the transmission element includes a sun gear.

15. The bicycle drive unit according to claim 13, further comprising
a crank axle included in the crank.
